(19) United States
(12) Patent Application Publication
(10) Pub. No.: US 2006/0207704 A1
(43) Pub. Date: Sep. 21, 2006

(54) Active solid tire

(75) Inventor: Chun-Feng Chen, Taichung Hsien (TW)

Correspondence Address: TROXELL LAW OFFICE PLLC, SUITE 1404, 5205 LEESBURG PIKE, FALLS CHURCH, VA, 22041, US

(73) Assignee: Ourway Engineering Co., Ltd.

(21) Appl. No.: 11/346,351

(22) Filed: Feb. 3, 2006

(30) Foreign Application Priority Data
Mar. 17, 2005 (TW) 94204096

(51) Int. Cl. B60C 3/02; B60C 7/00

(52) U.S. Cl. 152/327; 152/453

(57) ABSTRACT

An active solid tire, which is based on solid tire completely making from rubber or double-layer tube solid tire making from rubber layer and rubber or plastic foaming layer; its feature is as follows: with specific thickness as precondition, assemble a hollow pipe-shaped ring in inner center of solid tire making completely from rubber or foaming plastic material, or double-layer tube solid tire making completely from rubber layer and rubber or foaming plastic layer, so that this ring is covered in center of its inside, so, a hollow air chamber is formed accordingly, such solid tire may not have flat tire and better elasticity and shock-absorbing capability, its material cost and weight may also be reduced.

### BACKGROUND OF THE INVENTION

1) Field of the Invention

This invention relates to an active solid tire, which can provide comfort effect due to its better elasticity and shock-proof capability, also reduce material and production cost, lighten weight accordingly.

2) Description of the Prior Art

Usually, wheel is installed on facility transporting or moving material so as to reduce labor in transporting or moving load on facility and friction between weight of facility and ground, such as electrical bike, handcart, wheel chair, baby carriage or skate board car.

However, wheel is comprised by wheel rim and tire, as to tire, most are composed of tire tube filling air and tire cover making from rubber, so, as to wheel applying to handcart or skate board car, even electrical bike for aged persons or wheel chair for disabled person, because they are inconvenient to move, its tire tube should avoid flat tire or leak so that they can move forward continuously. Therefore, what tire industry is required to get improved at present is how to avoid and prevent above said matter from happening.

Solid tire has been thereby invented to shoot above said worry that it needn't fill air and prevent flat tire from happening.

As to current active solid tire, please refer to FIG. 1-A and FIG. 1-B, which is made from rubber or foaming plastic material 2, because cost of raw material is expensive, so, cost of tire making from rubber or foaming plastic material may be increased, therefore, it is required to get improved; secondly, tire making from rubber or foaming plastic material is heavier; further more, rubber is rigid and lacks elasticity so that such solid tire can not absorb shock producing from uneven ground, so, bodywork has poor shock-absorbing capability.

Furthermore, double-layer tube solid tire with cover making from rubber and tube making from rubber or foaming plastic material has also been invented, owing to this double-layer tube design, the rubber layer can bear heavy load and tire may not be pierced. Moreover, rubber or plastic foaming material of its tube are light and elastic with lower cost, therefore, its effect is better than above said solid tire making from rubber or plastic foaming material completely in material cost, weight and shock-absorbing.

However, above said solid tire, either made from rubber or foaming plastic material, or double-layer tube solid tire making from rubber layer and rubber or foaming plastic layer, because its inside is complete solid, so, its material cost is still expensive, also, its shock-absorbing capability reached is not perfect, moreover, please refer to FIG. 1-B, such solid tire (made from rubber or foaming plastic material completely), because of its complete solid structure, which installed on above said electrical bike, handcart, wheel chair, baby carriage or skate board car, if didn't use for a long time, weight of such facility may completely drop on this solid tire, the weight may totally be pressed towards bottom 21 of tire so as to press it almost close to ground 3 in parallel, tire may distort, its bottom 21 can not resume to round immediately when start moving forward again since solid tire can not be filled air and has better elasticity as air-filling tire, so, it may vibrate and can not move smoothly. It is why such solid tire is also required to get improved.

### SUMMARY OF THE INVENTION

This invention aims to solve disadvantage of above described structure, the main purpose is to provide an improved structure of active solid tire, which is completely made from rubber or foaming plastic material, or rubber layer and rubber or foaming plastic layer. A hollow pipe-shaped ring is assembled in center of its inside so that this ring is covered in center and form a hollow air chamber when manufacturing solid tire, therefore, it can reach better elasticity and shock-absorbing capability, reduce material consumption, cost and weight.

### BRIEF DESCRIPTION OF THE DRAWINGS

FIG. 1-A is the section embodiment sketch map of structure of the prior art.

FIG. 1-B is the section embodiment sketch map of structure of the prior art.

FIG. 2 is the exploded section view of this invention.

FIG. 3 is the exploded combination section view of this invention.

FIG. 4 is another executive exploded combination section view of this invention.

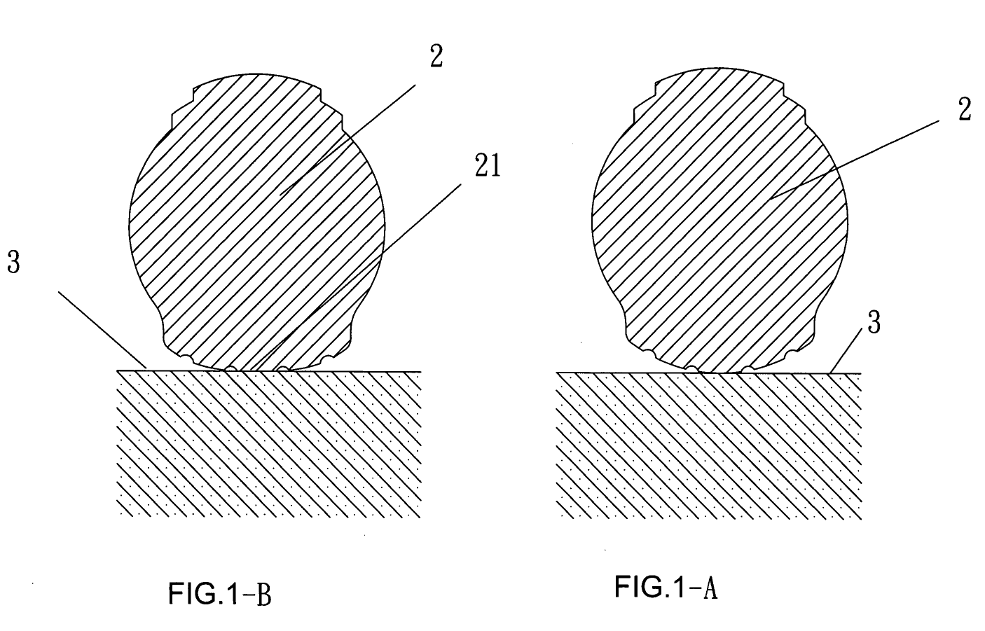

### DETAILED DESCRIPTION OF THE PREFERRED EMBODIMENTS

For your better reference, we hereby specially provide features and operation of this invention with descriptions of figure in the following.

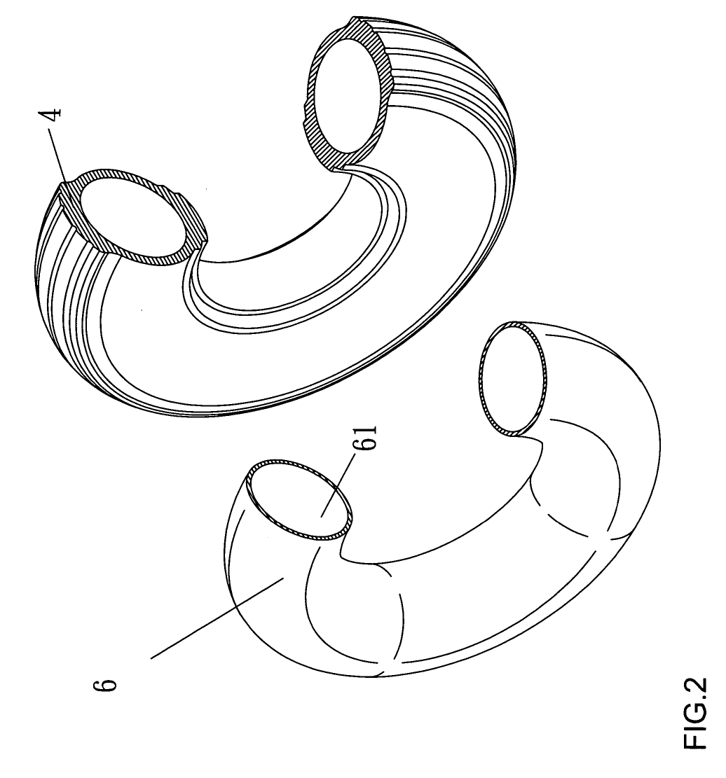

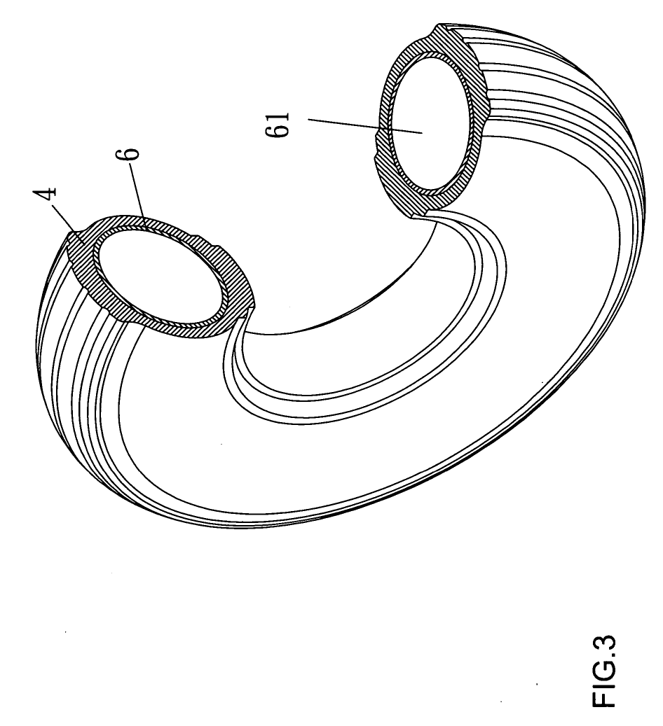

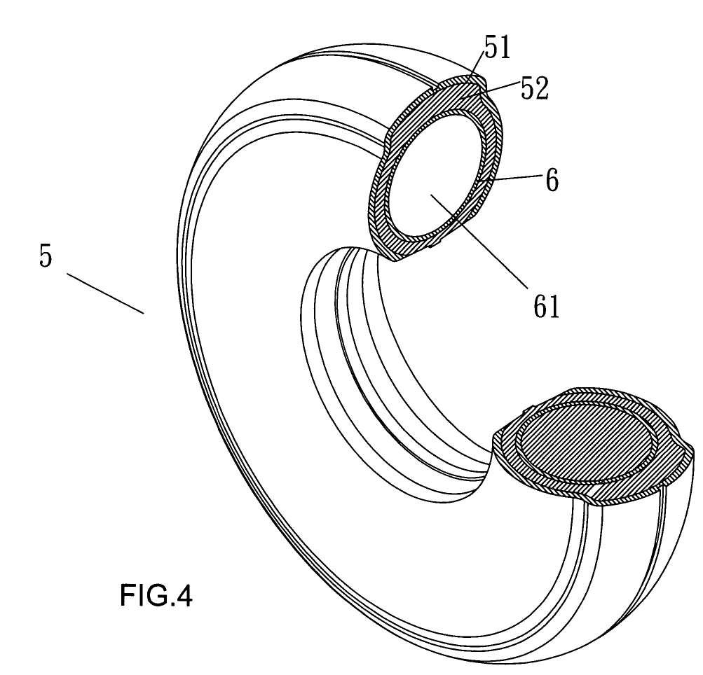

Please refer to FIG. 2, FIG. 3 and FIG. 4, the active solid tire created in this invention is the solid tire making completely from rubber or foaming plastic material 4, or double-layer tube solid tire 5 making from rubber layer 51 and rubber or foaming plastic layer 52 basing on normal active tire. Its feature is as follows: with specific thickness as precondition, assemble hollow pipe-shaped ring 6 in inner center of solid tire making completely from rubber or foaming plastic material 4, or double-layer tube solid tire 5 making completely from rubber layer 51 and rubber or foaming plastic layer 52, so that this ring 6 is covered in center of its inside, so, hollow air chamber 61 is formed accordingly.

According to above descriptions, as such solid tire is installed on electrical bike, handcart, wheel chair, baby carriage or skate board car, it has better elasticity and shock-absorbing capability owing to hollow air chamber 61 formed due to ring 6 covered in its inner center, further more, even if it is pierced into hollow air chamber 61 formed due to ring 6 covered in its inner center by nail, no matter double-layer tube solid tire that is made completely from rubber or foaming plastic material 4, or from rubber layer 51 and rubber or plastic foaming layer 52, may not have flat tire and can support weight of whole facility due to its thickness.

Moreover, such facilities including electrical bike, handcart, wheel chair, baby carriage or skate board car, even if didn't use them for a long time, their weight may totally drop on tire, however, owing to hollow air chamber 61 formed by ring 6 covered in its inner center, as they start moving again, shape of tire can immediately resume round and rotate smoothly.

Further more, it isn't necessary to fill rubber or foaming plastic material 4 or rubber or plastic foaming layer 52 into the spacing formed between hollow air chamber 61 and hollow pipe-shaped ring 6, so, materials for whole solid tire are reduced, its material cost and weight can also be decreased accordingly.

What is claimed is:

1. An active solid tire, which is based on solid tire completely making from rubber or foaming plastic material, or double-layer tube solid tire making from rubber layer and rubber or plastic foaming layer, its feature is as follows: with specific thickness as precondition, assemble a hollow pipe-shaped ring in inner center of solid tire making completely from rubber or foaming plastic material, or double-layer tube solid tire making completely from rubber layer and rubber or foaming plastic layer, so that this ring is covered in center of its inside, so, a hollow air chamber is formed accordingly, such solid tire may not have flat tire and better elasticity and shock-absorbing capability, its material cost and weight may also be reduced.
